(19) United States
(12) Patent Application Publication
(10) Pub. No.: US 2026/0206124 A1
(43) Pub. Date: Jul. 16, 2026

(54) MICROFOCUS LINEAR ACCELERATOR

(71) Applicant: VAREX IMAGING CORPORATION, Salt Lake City, UT (US)

(72) Inventor: Andrey Valentinovich Mishin, Salt Lake City, UT (US)

(21) Appl. No.: 19/023,145

(22) Filed: Jan. 15, 2025

(51) Int. Cl. H05H 7/22

(52) U.S. Cl. CPC H05H 7/22; H05H 2007/225

(57) ABSTRACT

Some embodiments herein include a linear accelerator (LINAC) comprising a particle source to generate charged particles, a radiofrequency (RF) source configured to generate RF power, and an accelerator structure coupled to the particle source and the RF source. The accelerator structure may include a plurality of cells arranged adjacent to one another. Each cell may define an accelerating cavity and an aperture into the accelerating cavity configured to receive the charged particles therethrough. The apertures of the cells may be each sized to output a beam with a focal spot size less than 0.5 millimeters Full Width at Half Maximum (FWHM) spot diameter without the use of external focusing mechanisms.

### TECHNICAL FIELD

This application relates generally to linear accelerator systems, and more particularly, to improvements to focusing of a beam of charged particles output by a linear accelerator system.

### BACKGROUND

Linear accelerators (LINACs) are devices that use electromagnetic fields to accelerate charged particles, such as electrons, to high energies. The accelerated particles may then be used to generate high-energy radiation which can penetrate dense materials. LINACs are versatile and have applications across multiple fields, including Non-Destructive Testing (NDT), Security Inspection (SI), and Radiotherapy (RT), for example.

In medicine, LINACS may be used in radiation therapy to treat cancer by delivering precise, high-energy beams to target tumors while minimizing damage to surrounding healthy tissue. In industrial imaging, LINACs can be used for NDT allowing for the inspection of dense materials and structures, such as pipelines, aerospace components, and welds, where conventional radiography methods may fall short. Additionally, LINACs can be employed in security and inspection systems, such as cargo scanning and border security, to detect contraband, explosives, and other hidden materials in dense containers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example linear accelerator system in accordance with some embodiments.

FIG. 2A illustrates a rear perspective view of a cell of a linear accelerator system in accordance with some embodiments.

FIG. 2B illustrates a front perspective view of the cell of the linear accelerator system in accordance with some embodiments.

FIG. 2C illustrates a front view of the cell of the linear accelerator system in accordance with some embodiments.

FIG. 2D illustrates a cross-sectional view of the cell of the linear accelerator system in accordance with some embodiments.

FIG. 3 is a cross-sectional view of a conventional radiofrequency (RF) structure of a linear accelerator (LINAC) in accordance with some embodiments.

FIG. 4 is a cross-sectional view of an example embodiment in which an On-Axis Coupled Biperiodic Structure (OACBPS) RF Structure that includes additional ports built into the accelerating cavities for tuning.

FIG. 5 is a cross-sectional view of a conventional Side Couple Bi-Periodic Structure (SCBPS) RF structure while measuring on-axis accelerating cavity eigen value frequency in accordance with some embodiments.

FIG. 6 is a cross-sectional view of a conventional SCBPS RF structure while measuring eigen value frequency for a specific off-axis coupling cavity in a conventional SCBPS in accordance with some embodiments.

FIG. 7 is a cross-sectional view of an example embodiment of a SCBPS RF structure while an on-axis accelerating cavity eigen value frequency is measured using side coupling cavities in accordance with some embodiments.

FIG. 8 is a cross-sectional view of an example embodiment of a SCBPS RF structure while off-axis coupling cavity eigen value frequency is measured using side coupling cavities.

FIG. 9 illustrates a method for manufacturing an accelerator structure of a linear accelerator in accordance with some embodiments.

FIG. 10 illustrates a method for manufacturing an accelerator structure of a linear accelerator in accordance with one embodiment.

FIG. 11 illustrates a method for manufacturing an accelerator structure of a linear accelerator in accordance with some embodiments.

FIG. 12 illustrates a method for inspecting an object using penetrating radiation in accordance with some embodiments.

### DETAILED DESCRIPTION

Embodiments herein refer to a linear accelerator (LINAC). A LINAC may employ electromagnetic fields to accelerate charged particles, such as electrons, to extremely high velocities. The LINAC may output a beam of charged particles. Embodiments may be used to focus a beam of electrons toward a target to generate radiation.

The size of the beam of charged particles output by the LINAC may affect the accuracy of the system. Focusing the beam to a smaller output in a LINAC system enhances its accuracy, whether the system is used for imaging or therapeutic applications. A smaller beam output may result in a more concentrated and precise delivery of energy, improving imaging fidelity and the accuracy of treatment.

A radiofrequency (RF) or microwave structure of a LINAC may include a plurality of cells that each define an acceleration cavity and a central aperture. The central aperture of such a microwave structure may be used for charged particle beam acceleration and propagation. The central aperture is designed based on many factors, such as optimization of the accelerating fields, thorough charged particle beam dynamics and RF design for better capture and transmission, etc.

The resulting beam diameter at the exit of such microwave structure may vary. In some LINAC systems, the beam diameter may be between 1.5 millimeters (mm) and 2.5 mm for some applications. However, reducing this beam diameter further may improve the accuracy of the system.

Smaller diameter focal beam spots are desired in many applications. For example, a smaller focal beam spot may be desirable for non-destructive testing (NDT), security screening, and radiation therapy. A smaller focal spot can result in better resolution for imaging applications and more accurate dose delivery in radiation therapy systems.

The focal spot size of a LINAC can be reduced using external focusing mechanisms, such as solenoid or focusing coils, quadrupoles, etc. These mechanisms are designed to manipulate the trajectory of charged particles, such as electrons, within the beam to achieve a tighter, more concentrated output. For example, systems using such external focusing mechanisms may be able to reduce the focal spot size to between 0.3 mm and 0.8 mm Full Width at Half Maximum (FWHM) spot diameter. In some examples, systems using such external focusing mechanisms may be able to reduce the focal spot size to between 0.5 mm and 0.8 mm, 0.2 mm and 1.0 mm, or between 0.1 mm and 1.2 mm, 0.5 mm to 0.05 mm or between 50 microns to 500 microns Full Width at Half Maximum (FWHM) spot diameter.

While external focusing mechanisms may be effective at reducing the beam diameter in LINAC systems, they also introduce additional complexities and costs. External magnetic systems are large in size, heavy, require additional high power consuming supplies, and are also expensive. Accordingly, such external focusing mechanisms may not be practical in certain situations (e.g., in commercial LINACs used in field deployed screening systems).

Embodiments described herein may provide a smaller beam spot without any external focusing. Reduction of the focal spot size to fractions of a millimeter and especially without any external focusing systems presents a serious challenge. For example, some embodiments herein include microwave structures that define a smaller central aperture used for charged particle beam propagation.

While a reduction of the microwave structure central aperture used for charged particle beam propagation does reduce the focal spot size, it also introduces additional complications. For example, reduction of the central aperture below 2.5 mm in diameter prevents the use of hard coaxial probes, which have practical minimum diameter of approximately 2.5 mm or greater, for measuring fields on beam axis in the accelerating cavities. This complicates traditional tuning techniques for the microwave structure. Moreover, such reduction in the central aperture creates manufacturing difficulties such as alignment challenges. Embodiments herein provide methods to overcome the challenges associated with a reduced central aperture of a microwave structure.

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

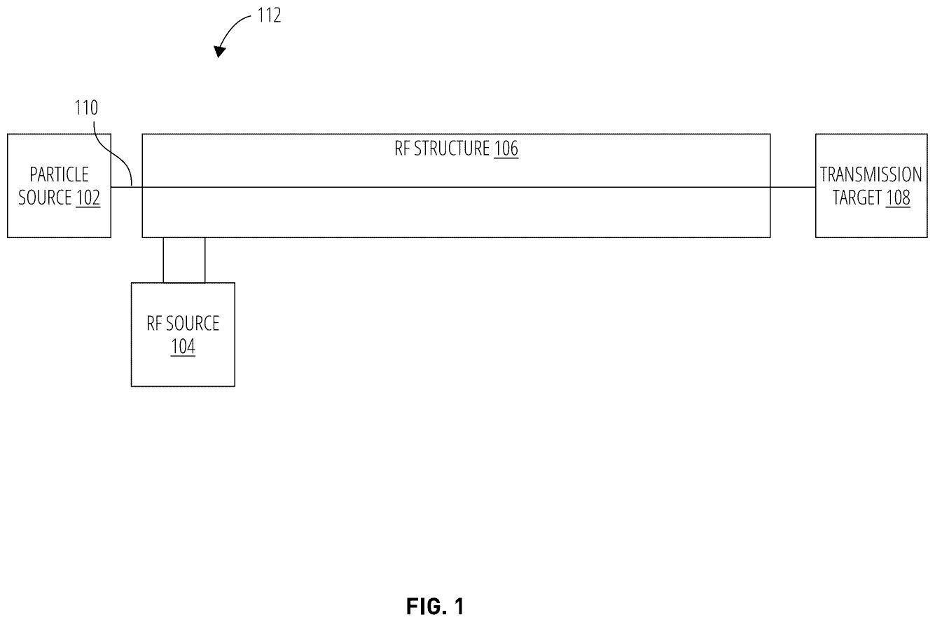

FIG. 1 illustrates a block diagram of an example LINAC system 112 in accordance with some embodiments. The LINAC system 112 may include a particle source 102, an RF source 104, an RF structure 106, and a transmission target 108. The LINAC system 112 may accelerate charged particles and guide the accelerated charged particles to the transmission target 108 to generate radiation (e.g., bremsstrahlung (X-rays)).

The particle source 102 may generate a charged particle beam 110 that is emitted into the RF structure 106. The charged particle beam 110 may be electrons, protons, or ions. In some embodiments, the particle source 102 may be an electron gun which may generate an electron beam. The particle source 102 (e.g., electron gun) may largely define the input beam, which, in turn, affects the output beam and the focal spot size. In some embodiments, the particle source 102 may be configured to emit a small beam. Some embodiments may include a needle-like adjustable field emitter, thermionic or simply a field emitter, for the penetration depth regulation, inserted through an inlet central aperture of the LINAC system 112 into the RF fields of the first accelerating or bunching cavity. The depth may define RF field amplitude, and, therefore, the emission current for its selection in the process of LINAC operation.

The RF source 104 may provide RF power for the LINAC system 112. The RF power may produce high-frequency electromagnetic waves that create alternating electric fields in the RF structure 106 to transfer energy to the particles. The electromagnetic waves are used to accelerate the charged particle beam 110 in the RF structure 106. In some embodiments, the RF source 104 may be a magnetron or a klystron.

The RF structure 106 bunches and accelerates the particles of the charged particle beam 110 through interaction with RF-generated electric fields from the RF source 104. The RF structure 106 includes a plurality of cells arranged adjacent to one another, each cell defining an accelerating cavity and a central aperture into the accelerating cavity configured to receive the charged particles therethrough. The RF structure 106 guides and accelerates the particle beam through successive cavities with synchronized electric fields. The cavities gradually increase in length in the direction of the charged particle beam 110 propagation to keep the particles in the right accelerating phase while their velocity increases. Once particle velocity reaches nearly the speed of light, the period of the structure and the shape of the accelerating cells usually remain the same until the end of the accelerator. The RF structure 106 guides the charged particle beam 110 to the transmission target 108.

The central aperture of the cells may shape the charged particle beam 110. A small central aperture may be used to make the focal spot size on the target smaller. In some embodiments, the central apertures of the cells are each sized to output a beam with a focal spot size less than 0.5 millimeters FWHM spot diameter without magnets. The apertures of each of the cells may have a diameter of less than 2.5 millimeters (e.g., between one millimeter and 2.5 millimeters).

The RF structure 106 is a standing wave structure that uses the RF-generated electric fields from the RF source 104 to accelerate charged particles. The RF structure 106 may be an on-axis coupled standing wave structure or an off-axis coupled standing wave structure. An on-axis coupled standing wave structure is formed when the coupling cavities are located in line with the accelerating cavities. An off-axis coupled standing wave structure is formed when the coupling cavities are moved to periphery of the accelerating cavities. Both types of structures may be magnetically coupled and biperiodic to increase efficiency of acceleration, but the latter side coupled structure may be more efficient as the electron beam sees “π” mode in the accelerating cavities, while the structure operates in “π/2” mode from the microwave fields and phase shifts standpoint. This can ensure a high value of the effective shunt impedance.

The charged particle beam 110 gains energy while propagating through the RF fields of the cavities in the RF structure 106, and after it exits the RF structure 106, the charged particle beam 110 may be extracted outside the vacuum envelope for charged beam applications, or it may strike a heavy metal target to generate bremsstrahlung (X-rays).

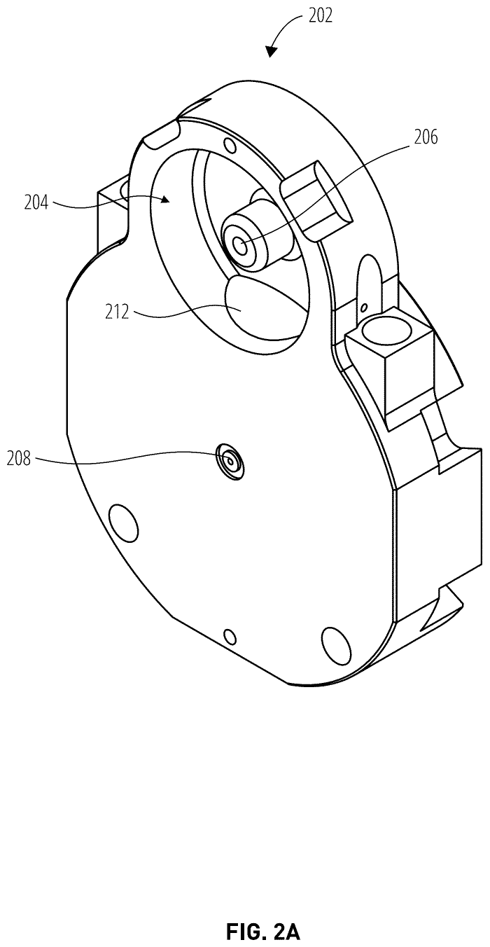

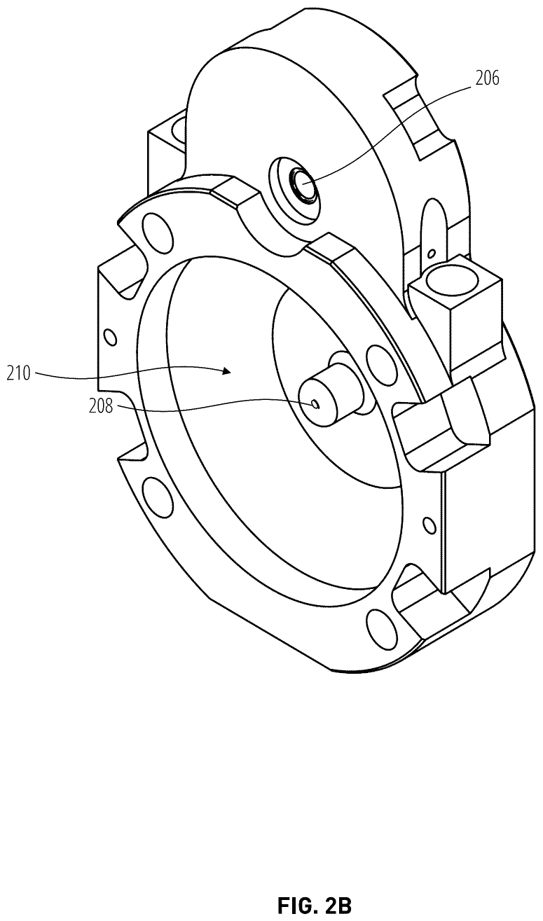

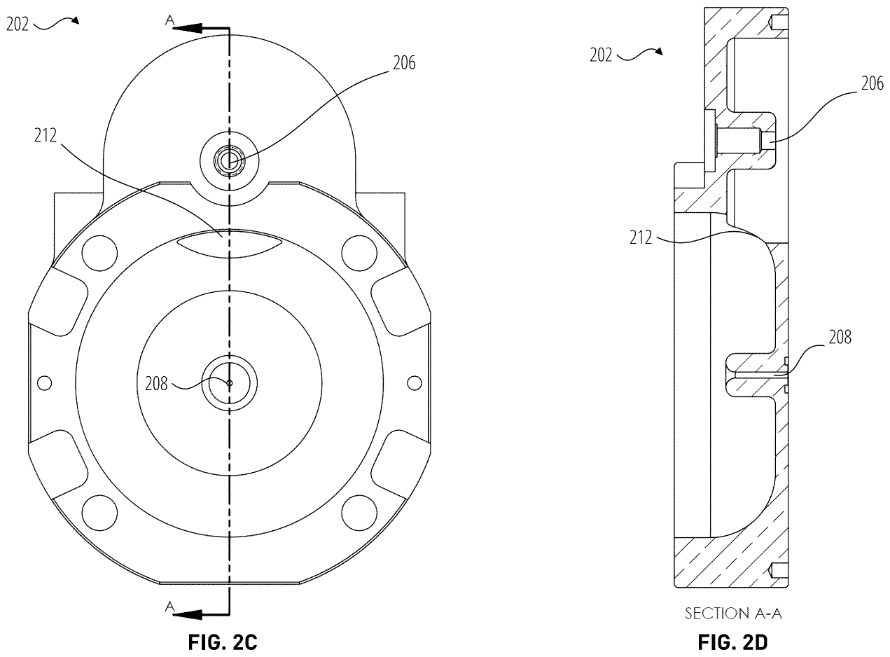

Each of the cells of the RF structure 106 may comprise a chamber body that defines an accelerating cavity and a coupling cavity. The accelerating cavities and coupling cavity are chambers defined on the chamber body. As previously mentioned, the cells may be on-axis coupled or off-axis coupled. FIGS. 2A-2D illustrate an example embodiment of a cell 202 that includes a side coupling cavity for off-axis coupling in accordance with some embodiments.

FIG. 2A illustrates a rear perspective view of a cell 202 of a LINAC system in accordance with some embodiments. As shown in FIG. 2A the cell 202 may include a coupling cavity 204. Further, FIG. 2B illustrates an example accelerating cavity 210 of the cell 202. The coupling cavity 204 may be configured to distribute RF energy trough a plurality of cells and the accelerating cavity 210 may be configured to efficiently accelerate particles.

The coupling cavity 204 may be adjacent the accelerating cavity 210 and positioned off-axis to the charged particle beam. The coupling cavity 204 may be connected to the accelerating cavity 210 via a coupling slot 212. The coupling cavity 204 plays a role in the transfer of RF energy between neighboring cells. The coupling slot 212 may be shaped and positioned to enable efficient energy transfer while maintaining phase synchronization and minimizing reflections. The coupling cavity 204 can be tuned to resonate at the same frequency as the accelerating cavity 210 to provide stable and uniform RF power distribution throughout the LINAC structure.

The coupling cavity 204 may be a side cavity that is configured for tuning the LINAC structure. For example, the coupling cavity 204 may include a coupling cavity aperture 206. The coupling cavity aperture 206 may provide an opening into the coupling cavity aperture 206. The coupling cavity aperture 206 may be sized and shaped to receive a tuning probe or a shorting rod for tuning. For example, in some embodiments, the coupling cavity aperture 206 may have a diameter of at least 2.5 millimeters.

In the illustrated embodiment, the coupling cavity aperture 206 includes a central aperture. The central aperture may permit a rod or a probe to be inserted through multiple cavities of aligned holes. In other embodiments, instead of a central aperture, the coupling cavity 204 may define side holes positioned on the circumference of the coupling cavity 204 allowing for the probes and/or shorts to go through the coupling cavity 204 from the side. Such a side cavity could be at 90 degrees to the beam axis, or at a different angle.

The cell 202 may define accelerating cavity aperture 208 into the accelerating cavity. The accelerating cavity aperture 208 is configured to receive the charged particles therethrough. Allowing tuning instruments to be inserted into the coupling cavity 204 through the coupling cavity aperture 206 may allow the diameter of the accelerating cavity aperture 208 to be reduced to a size smaller than the tuning instruments. The size of the accelerating cavity aperture 208 in a LINAC system is correlated to the size of the output particle beam, as the aperture directly influences beam confinement and focus during acceleration. A smaller aperture results in a tighter confinement of the beam as it passes through the cavity, which translates to a smaller and more focused output beam size. In some embodiments, the apertures of each of the cells have a diameter of less than 2.5 millimeters.

FIG. 2B illustrates a front perspective view of the cell of the LINAC system in accordance with some embodiments. As shown, the cell 202 may defining an accelerating cavity 210 and an accelerating cavity aperture 208 configured to receive the charged particles therethrough.

The accelerating cavity can be a cylindrical or disk-shaped structure positioned along the central beamline, defining an accelerating cavity aperture that serves as the passage for charged particles. This accelerating cavity aperture 208 may be carefully aligned neighboring cells apertures and the beam axis. Inside the accelerating cavity 210, the walls may be contoured to support a transverse magnetic (TM) mode resonating at a predetermined RF frequency, generating an oscillating electric field along the beam axis. The particles gain energy as they pass through this electric field. Body of the cell may be constructed from high-conductivity materials, such as copper, to minimize resistive losses and enhance performance.

The accelerating cavity aperture 208 may be a central aperture for beam propagation in aligned accelerating cavities of neighboring cells. The accelerating cavity aperture 208 may be reduced below the minimum diameter allowing the probe to go through this aperture, but still permitting a thin rod to go through such aperture for detuning the accelerating cavities. The eigen frequency value of the accelerating cavities 210 may be measured through the coupling cavities 204.

In some embodiments, the accelerating cavity aperture 208 may allow for alignment. In some embodiments, alignment of the assembled cells to form set of cavities may be performed using a thin rod, which fits into the small accelerating cavity aperture 208, while the assembled set of cells is positioned vertically for brazing. The aligning rod may be removed after completion of the stack installation into the brazing furnace and before closing the bell jar for brazing.

The accelerating cavity aperture 208 may be formed in a variety of ways. In some embodiments, the accelerating cavity aperture 208 may be machined individually into each cell. In other embodiments, the accelerating cavity aperture 208 may be produced by brazing the cells first and then producing a straight through hole through all irises at once using a laser or another similar tool.

In some embodiments, the cell may be on-axis coupled and the accelerating cavity may further define a side hole positioned on a circumference of the accelerating cavities and configured to allow a tuning probe or a shorting rod to be placed through the accelerating cavities from a side.

FIG. 2C illustrates a front view of the cell 202 of the LINAC system in accordance with some embodiments. The cell 202 may be coupled to a set of neighboring cells to form chambers for particle acceleration. FIG. 2D illustrates a cross-sectional view of the cell 202 taken through section A-A in accordance with some embodiments. As shown, the accelerating cavity aperture 208 may be smaller than the coupling cavity aperture 206.

The coupling cavity aperture 206 may be smaller than a measurement probe and therefore may not allow for direct use for tuning. Instead, in some embodiments the coupling cavity aperture 206 may be sized to receive probes for eigen frequency value measurements. For example, in some embodiments the accelerating cavity aperture 208 may have a diameter of less than 2.5 millimeters, and the coupling cavity aperture 206 greater than or equal to 2.5 millimeters. In some embodiments, the accelerating cavity aperture 208 may have a diameter of between one millimeter and 2.5 millimeters. The accelerating cavity aperture 208 may be sized to output a beam with a focal spot size less than 0.5 millimeters FWHM spot diameter without an external focusing mechanism.

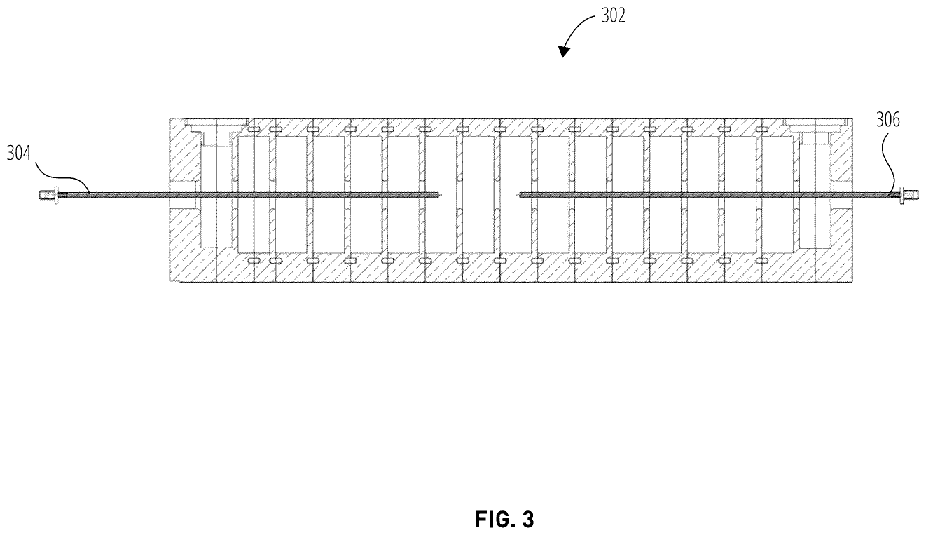

One issue that arises from making the accelerating cavity aperture 208 smaller is tuning. For example, FIG. 3 is a cross-sectional view of a conventional RF structure 302 of a LINAC in accordance with some embodiments. Tuning an RF structure in a LINAC involves precisely adjusting the resonant frequency of the cavities to ensure proper phase synchronization and efficient particle acceleration. The illustrated conventional RF structure 302 is an on-axis coupled microwave structure. One method for tuning the conventional RF structure 302 is by inserting electrical probes (e.g., first electrical probe 304 and second electrical probe 306) through the accelerating cavity apertures (these apertures may be referred to as beam apertures, irises, or central apertures) of the accelerating cavities to measure the frequency in the π/2 mode.

However, reduction of the central aperture below the minimum possible diameter of the probes leaves no way to tune the conventional RF structure 302. For example, reduction of the central aperture below 2.5 mm in diameter may prevent the use of hard coaxial probes, which have a practical minimum diameter of approximately 2.5 mm for measuring fields on the beam axis in the accelerating cavities. Accordingly, the conventional RF structure 302 would have a limit to the amount the central apertures may be reduced due to tuning. This also limits how much the focal spot size may be reduced without the use of an external focus mechanism.

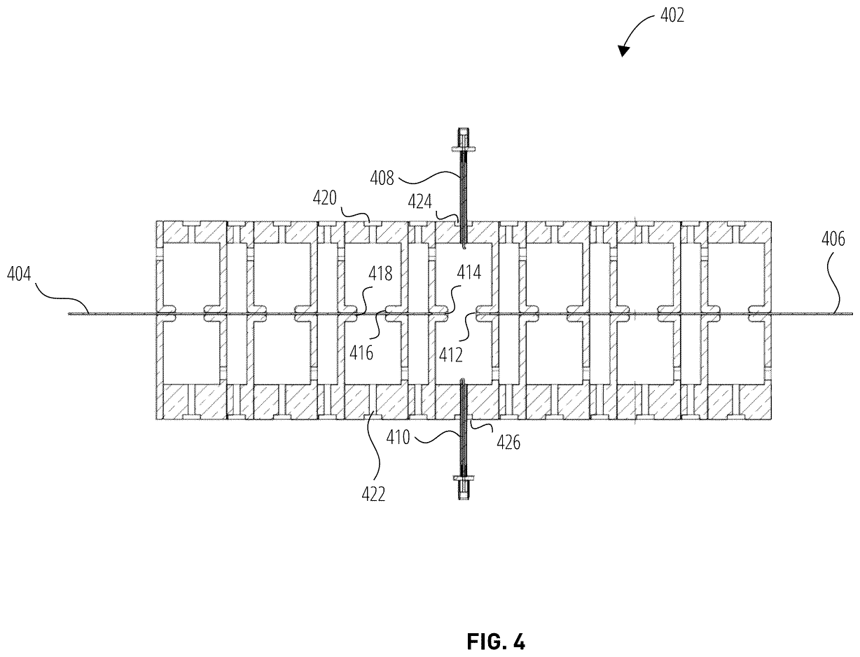

As shown in FIG. 4, embodiments in which the accelerating cavity apertures of an on-axis coupled RF structure are reduced to a smaller diameter than a hard coaxial electrical probe, tuning may be performed via a different set of apertures on the side or circumference of the accelerating cavities. Specifically, FIG. 4 is a cross-sectional view of an example embodiment in which an On-Axis Coupled Biperiodic Structure (OACBPS) RF Structure (e.g., RF structure 402) that includes additional ports (e.g., side aperture 420, side aperture 422, side aperture 424, and side aperture 426) built into the accelerating cavities for tuning. In some embodiments, the same ports can be built in a side coupled biperiodic structure (SWBPS).

For simplicity the tuning ports (e.g., side aperture 420, side aperture 422, side aperture 424, and side aperture 426) and the central apertures (e.g., accelerating cavity aperture 412, accelerating cavity aperture 414, accelerating cavity aperture 416, and accelerating cavity aperture 418) are only labeled for two cavities. However, as shown, each accelerating cavity may include two central apertures for the beam to pass through and two tuning ports on the sides of the cavities.

The cavities in the RF structure 402 may be designed to allow frequency to be pastured through a pair of additional holes (e.g., side aperture 420, side aperture 422, side aperture 424, and side aperture 426). Detuning may be done by inserting rods (e.g., first detuning rod 404 and a second detuning rod 406) through the central apertures to detune neighboring cavities. A first electrical probe 408 and a second electrical probe 410 may be inserted into the cavity to be measured through the tuning ports (e.g., side aperture 424 and side aperture 426).

For tuning, a technician may insert the detuning rods into neighboring cells via the central opening and insert electrical probes into the cavity to be measured through the tuning ports on the side of the cavity. An RF signal generator may be used to excite the cavity structure, creating standing electromagnetic waves. The induced signal on the electrical probes may be analyzed to determine the resonant frequency of the cavity structure. The frequency may be measured at the π/2 mode by observing the response curve. Each of the cells may be measured using this technique. Once the frequency is measured, adjustments may be made to ensure that the resonant frequency matches the desired operating frequency of the RF structure 402.

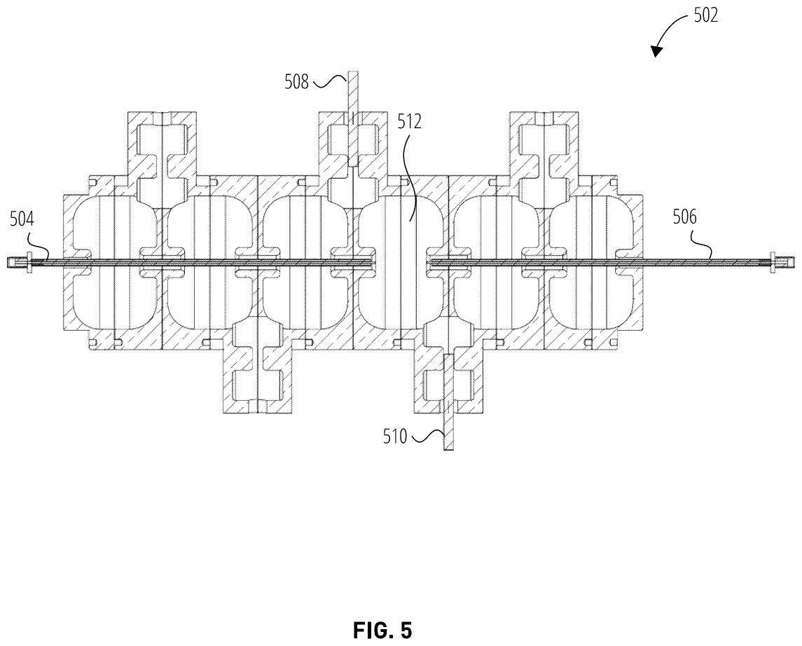

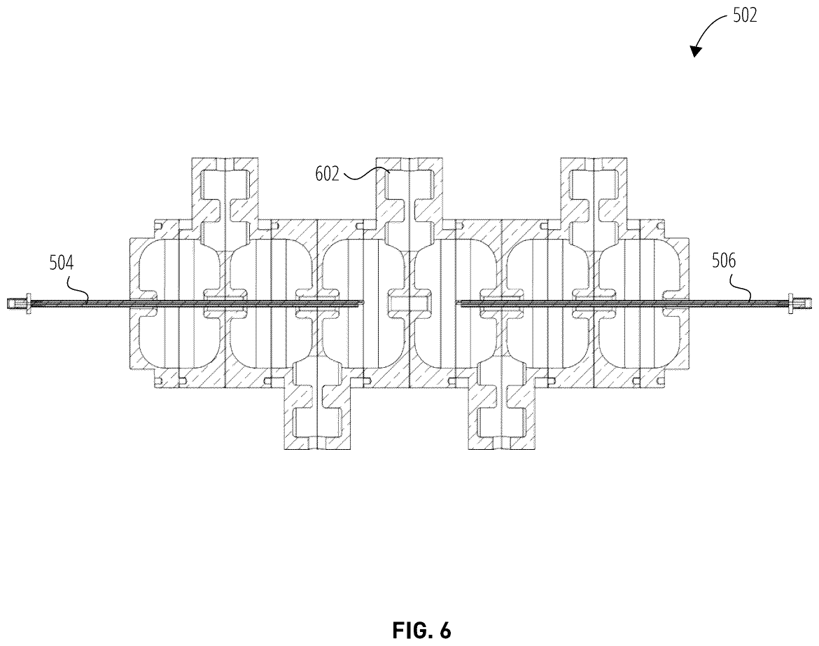

Similarly new ports for tuning may be introduced to Side Couple Bi-Periodic Structure (SCBPS) to allow the central aperture of the accelerating cavities to be reduced. A conventional way of tuning the Side Couple Bi-Periodic Structure (SCBPS) is shown in FIG. 5 (for on-axis or “accelerating” cavities) and FIG. 6 (for off-axis or “Coupling” cavities). In an SCBPS, coupling cavities are positioned off-axis relative to the beamline. These side-coupled cavities are connected to the primary accelerating cavities via coupling slots or openings.

Specifically, FIG. 5 is a cross-sectional view of a conventional SCBPS RF structure 502 while measuring on-axis accelerating cavity eigen value frequency in accordance with some embodiments. As shown, the magnetic probes (e.g., first magnetic probe 504 and second magnetic probe 506) can be positioned at the specific accelerating cavity 512 to be measured by inserting the probes through the central aperture of the accelerating cavities. The neighboring side cavities may be detuned by special plungers (e.g., plunger 508 and plunger 510).

In FIG. 5, On-Axis Accelerating Cavities are measured. For the selected accelerating cavity 512, two electrical probes are moved and positioned in the drift tubes to excite the accelerating cavity and pick up a minimized signal from it, while the neighboring coupling cavities are detuned by inserting the rods or similar elements (e.g., plunger 508 and plunger 510) between the noses of the side cavities.

FIG. 6 is a cross-sectional view of a conventional SCBPS RF structure 502 while measuring eigen value frequency for a specific off-axis coupling cavity 602 in a conventional SCBPS in accordance with some embodiments. As shown, the magnetic probes (e.g., first magnetic probe 504 and second magnetic probe 506) can be inserted through the central aperture in on-axis accelerating cavities. The eigen value frequency for a specific off-axis coupling cavity 602 may be measured using the first magnetic probe 504 and the second magnetic probe 506.

In FIG. 6, Off-Axis Coupling Cavities are measured. For the selected coupling cavity 602, two magnetic probes (with loops) may be position near the centers of the two neighboring on-axis accelerating cavities (which are detuned, therefore). The cavity may be excited, and frequency of the coupling cavity may be measured.

However, reduction of the central aperture below the minimum possible diameter of the probes leaves no way to tune the accelerating cavities and the coupling cavities of the conventional SCBPS RF structure 502. For example, reduction of the central aperture below 2.5 mm in diameter may prevent the use of hard coaxial probes, which have a practical minimum diameter of approximately 2.5 mm for measuring fields on the beam axis in the accelerating cavities. Accordingly, the conventional SCBPS RF structure 502 would have a limit to the amount the central apertures may be reduced due to tuning. This also limits how much the focal spot size may be reduced without the use of an external focus mechanism.

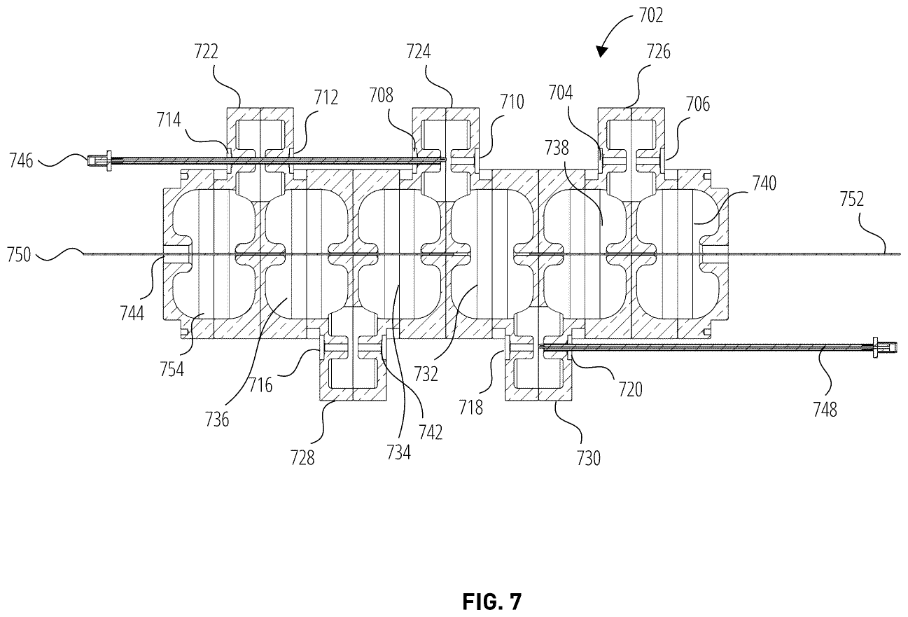

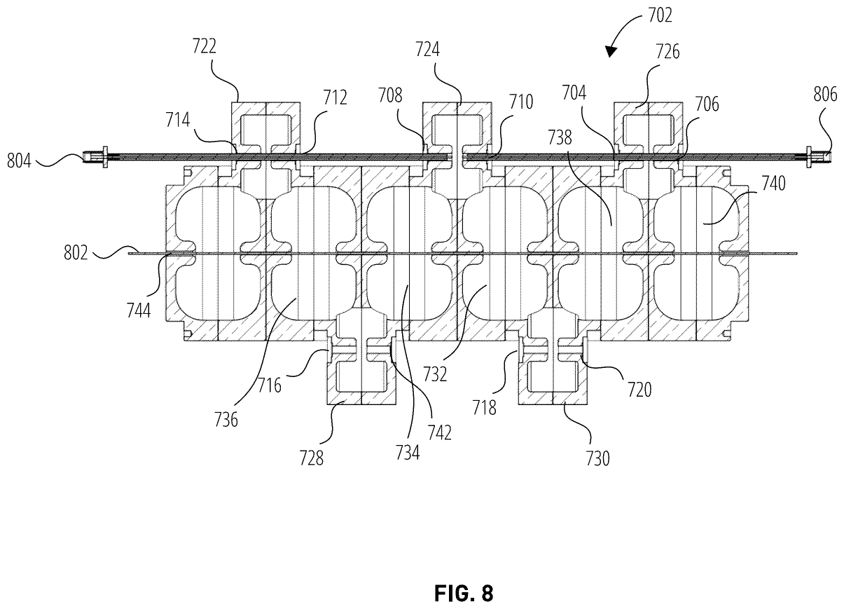

As shown in FIG. 7 and FIG. 8, embodiments in which the central accelerating cavity apertures of an SCBPS are reduced to a smaller diameter than a hard coaxial electrical probe, tuning may be performed via a different set of apertures in the side coupling cavities. Specifically, FIG. 7 illustrates a technique to measure an on-axis accelerating cavity eigen value frequency using magnetic probes inserted through neighboring side cavities. FIG. 8 illustrates a way to measure off-axis coupling cavity eigen value frequency using electrical probes through neighboring side cavities and a shorting rod through central beam accelerating cavities aperture.

FIG. 7 is a cross-sectional view of an example embodiment of a SCBPS RF structure 702 while an on-axis accelerating cavity eigen value frequency is measured using side coupling cavities configured for tuning the SCBPS RF structure 702 in accordance with some embodiments. In the illustrated embodiment, each of the side coupling cavities (e.g., side coupling cavity 722, side coupling cavity 724, side coupling cavity 726, side coupling cavity 728, and side coupling cavity 730) further define a side aperture configured to receive a tuning instrument (e.g., probe or a shorting rod for tuning).

In some embodiments the each of the side coupling cavities comprise two sets of side coupling cavities on opposite sides of the accelerating cavities (e.g., accelerating cavity 732, accelerating cavity 734, accelerating cavity 736, accelerating cavity 738, accelerating cavity 754, and accelerating cavity 740). In the illustrated embodiment, a first set of side coupling cavities includes side coupling cavity 722, side coupling cavity 724, and side coupling cavity 726. On the opposite side of the accelerating cavities, the illustrated embodiment includes a second set of side coupling cavities comprising side coupling cavity 728 and side coupling cavity 730.

In some embodiments, each side coupling cavity may define a central aperture (e.g., central tuning aperture 704, central tuning aperture 706, central tuning aperture 708, central tuning aperture 710, central tuning aperture 712, central tuning aperture 714, central tuning aperture 716, central tuning aperture 718, central tuning aperture 720, and central tuning aperture 742) such as it would be an accelerating cavity. For example, the side coupling cavities may have a central aperture drilled.

The two sets of side cavities and the accelerating cavities may have a parallel axis and aligned central apertures in each cavity, wherein the central apertures of the two sets of side cavities are sized and shaped to permit a shorting rod or a tuning probe through multiple of the side cavities, and the central aperture 744 of the accelerating cavities may receive shorting rod. The central apertures of the side coupling cavities may allow a probe or a rod to go through all or some of the apertures of the side coupling cavities positioned on the same side of the on-axis accelerating cavities.

With the central tuning apertures of the side coupling cavities, the standard tuning procedure can be improved. For example, instead of using magnetic probes with loops to tune the side cavities while looking at them through the on-axis accelerating cavities, the process can be reversed, and one can use electrical probes to excite and measure resonance frequency of each coupling cavity by simply putting the probes through the central aperture of such set of coupling cavities and a detuning rod through the central aperture of the accelerating cavities.

For instance, in FIG. 7 a first magnetic probe 746 and a second magnetic probe 748 are inserted through neighboring side cavities to measure on-axis accelerating cavity eigen value frequency. Further, shorting rod 750 and shorting rod 752 are inserted through the central aperture of the accelerating cavities such that the on-axis cavities on the right and on the left from the measured accelerating cavity 732 are shorted. In the illustrated embodiment accelerating cavity 734, accelerating cavity 736, accelerating cavity 738, accelerating cavity 754, and accelerating cavity 740 are shorted by shorting rod 750 and shorting rod 752.

For both the On-Axis Accelerating cavities and Off-Axis Coupling cavities, the central tuning apertures of the side coupling cavities may provide ways of measuring the eigen values and tuning the accelerating cavities and coupling cavities. Such a design and tuning method may permit the central beam aperture of the accelerating cavities to be reduced to values below a realistic smallest probe diameter while still allowing the SCBPS RF structure 702 to be tuned. The shorting rod (e.g., detuning rod 802 of FIG. 8) still can be inserted in the central beam aperture of the accelerating cavities to help in tuning of the microwave structure.

Example tuning setups are shown in FIG. 7 and FIG. 8. In FIG. 7 the first magnetic probe 746 and second magnetic probe 748 are used to measure small aperture on-axis accelerating cavity (e.g., accelerating cavity 732) eigen value frequency. In the illustrated embodiment, the first magnetic probe 746 and the second magnetic probe 748 are inserted through neighboring side cavities (side coupling cavity 724 and side coupling cavity 730) of the accelerating cavity 732 to be measured. The probes may be used to excite and measure resonance frequency of the accelerating cavity 732 to be measured. Once the frequency is measured, adjustments may be made to ensure that the resonant frequency matches the desired operating frequency of the SCBPS RF structure 702.

FIG. 8 is a cross-sectional view of an example embodiment of a SCBPS RF structure 702 while off-axis coupling cavity eigen value frequency is measured using side coupling cavities configured for tuning the SCBPS RF structure 702 in accordance with some embodiments. As shown, the small aperture off-axis coupling cavity (e.g., side coupling cavity 724) eigen value frequency may be measured using electrical probes (e.g., first electrical probe 804 and second electrical probe 806) through neighboring side cavities and a shorting rod (e.g., detuning rod 802) positioned through central beam accelerating cavities aperture.

The probes may be used to excite and measure resonance frequency of the side coupling cavity 724 to be measured. Once the frequency is measured, adjustments may be made to ensure that the resonant frequency matches the desired operating frequency of the SCBPS RF structure 702.

Moving the tuning ports to the coupling cavities may allow the beam apertures of the accelerating cavities to be reduced as there is no longer a need to insert a first electrical probe through the beam apertures. For example, the tuning cavities may have a diameter greater than or equal to 2.5 mm while the beam apertures may be less than 2.5 mm. The reduction of the beam apertures may reduce the focal spot size without the need for external focusing mechanisms.

Embodiments herein that include small beam apertures can provide a small focal spot size. In some embodiments, the beam aperture may be less than 2.5 mm. For example, a beam aperture of a LINAC with a beam aperture of 1.2 mm in diameter may output an electron beam of FWHM diameter in the range of 350±150 μm. In some embodiments, the beam apertures may have a 0.2 mm diameter with a spot of 0.1-0.2 mm.

Further, the electron injector configuration largely defines the size of the injected beam, which, in turn, defines the size of the output beam and the focal spot size, correspondingly. Further reduction of spot size is possible via a reduction of the injected beam diameter and of the aperture in the microwave structure. In some embodiments, the LINAC system may use a needle-like adjustable emitter, thermionic or simply a field emitter, with regulated emitter penetration depth into a microwave cavity, inserted through the inlet central aperture of the LINAC into the RF fields of the first accelerating or bunching cavity. The penetration depth may define RF field amplitude on the emitter surface, and, therefore, the emission current for its selection in the process of LINAC operation.

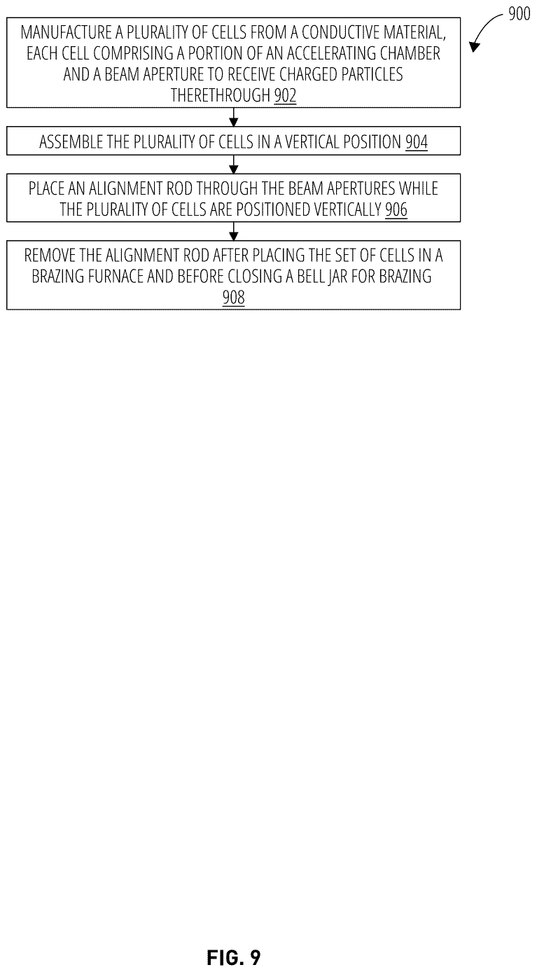

FIG. 9 illustrates a method 900 for manufacturing an accelerator structure of a linear accelerator in accordance with some embodiments. The illustrated method 900 includes manufacturing 902 a plurality of cells from a conductive material, each cell comprising a portion of an accelerating chamber and a beam aperture to receive charged particles therethrough. The method 900 further includes assembling 904 the plurality of cells in a vertical position. The method 900 further includes placing 906 an alignment rod through the beam apertures while the plurality of cells are positioned vertically. The method 900 further includes removing 908 the alignment rod after placing the set of cells in a brazing furnace and before closing a bell jar for brazing.

In some embodiments, the beam apertures are sized to output a beam with a focal spot size less than 0.5 millimeters FWHM spot diameter free of magnets. In some embodiments, the beam apertures have a diameter of between one millimeter and 2.5 millimeters. In some embodiments, the method 900 further comprises tuning the accelerator structure by inserting a tuning probe or shorting rod into tuning holes of a set of coupling chambers of the plurality of cells. In some embodiments the tuning holes are perpendicular to the beam apertures. In some embodiments, the tuning holes are parallel with the beam apertures and the tuning probe or shorting rod extends through multiple coupling chambers. In some embodiments, the method 900 further comprises tuning the accelerator structure by inserting a tuning probe or shorting rod into tuning holes along a diameter of the cells.

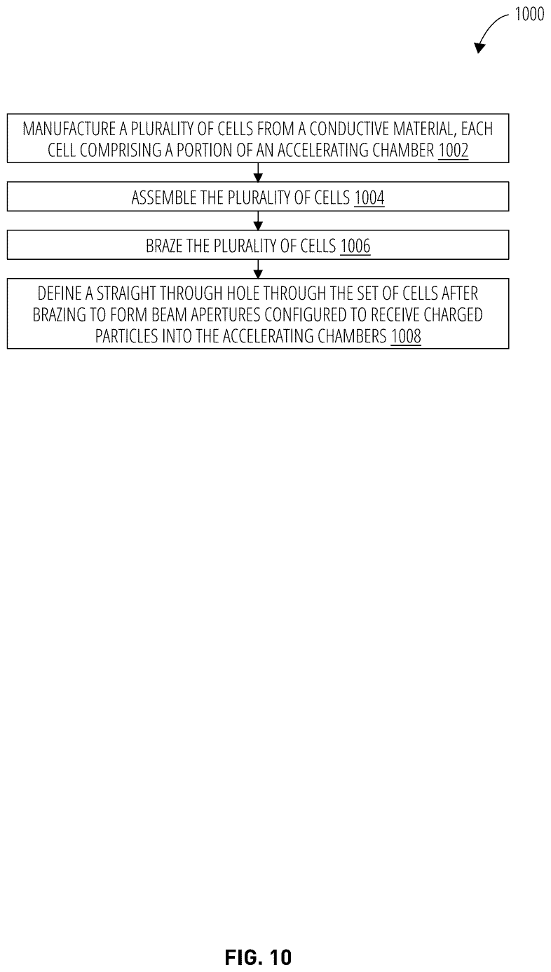

FIG. 10 illustrates a method 1000 for manufacturing an accelerator structure of a linear accelerator in accordance with one embodiment. The illustrated method 1000 includes manufacturing 1002 a plurality of cells from a conductive material, each cell comprising a portion of an accelerating chamber. The illustrated method 1000 further includes assembling 1004 the plurality of cells. The illustrated method 1000 further includes brazing 1006 the plurality of cells. The illustrated method 1000 further includes defining 1008 a straight through hole through the set of cells after brazing to form beam apertures configured to receive charged particles into the accelerating chambers. In some embodiments, the straight through hole is produced using a laser. In some embodiments, the straight through hole is sized to output a beam with a focal spot size less than 0.5 millimeters Full Width at Half Maximum (FWHM) spot diameter without magnets. In some embodiments, the straight through hole has a diameter of less than 2.5 millimeters.

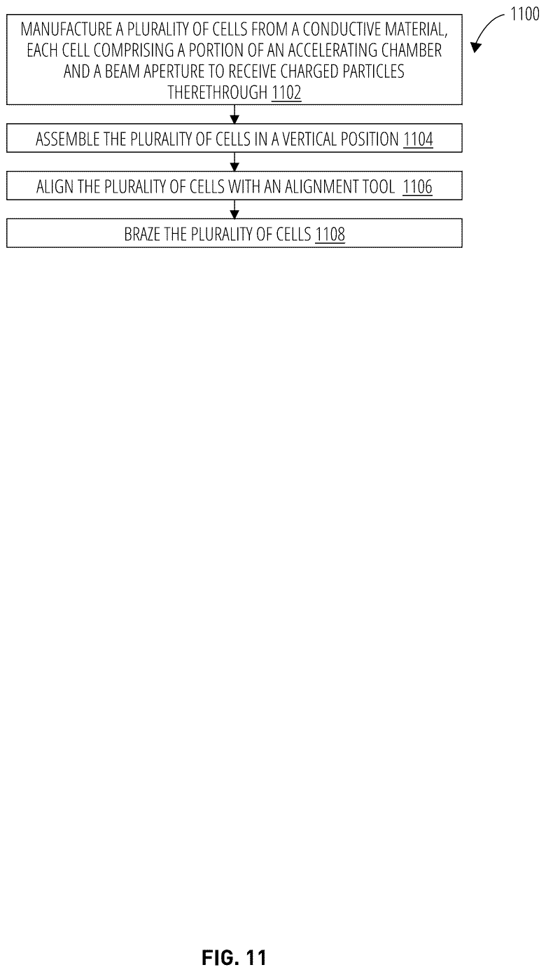

FIG. 11 illustrates a method 1100 for manufacturing an accelerator structure of a linear accelerator in accordance with one embodiment. The illustrated method 1100 includes manufacturing 1102 a plurality of cells from a conductive material, each cell comprising a portion of an accelerating chamber and a beam aperture to receive charged particles therethrough. The illustrated method 1100 further includes assembling 1104 the plurality of cells in a vertical position. The illustrated method 1100 further includes aligning 1106 the plurality of cells with an alignment tool. The illustrated method 1100 further includes brazing 1108 the plurality of cells. In some embodiments, the alignment tool comprises an alignment rod. In some embodiments, the alignment tool comprises a laser.

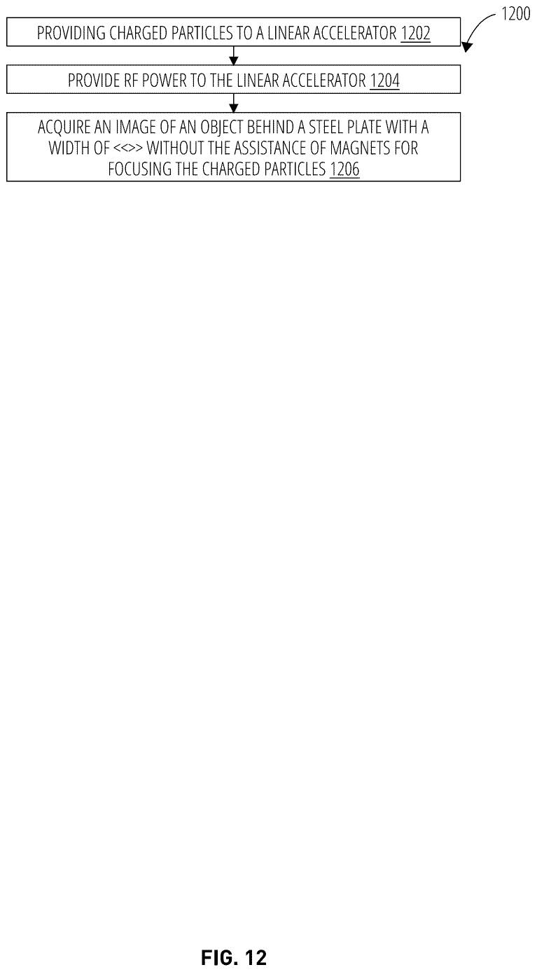

FIG. 12 illustrates a method 1200 for inspecting an object using penetrating radiation in accordance with some embodiments. The illustrated method 1200 includes providing 1202 charged particles to a linear accelerator. The illustrated method 1200 further includes providing 1204 RF power to the linear accelerator. The illustrated method 1200 further includes acquiring 1206 an image of an object behind a steel plate with a width of greater than one inch without the assistance of magnets for focusing the charged particles.

In some embodiments, the linear accelerator comprises a plurality of cells defining accelerating cavities and apertures into the accelerating cavities. In some embodiments, the apertures are sized to output a beam with a focal spot size less than 0.5 millimeters FWHM spot diameter free of magnets. In some embodiments, the apertures of the cells have a diameter of less than 2.5 millimeters.

The following are a number of exemplary embodiments detailed above:

Example 1: A linear accelerator comprising a particle source to generate charged particles; a radiofrequency (RF) source configured to generate RF power; and an accelerator structure coupled to the particle source and the RF source, the accelerator structure comprising a plurality of cells arranged adjacent to one another, each cell defining an accelerating cavity and an aperture into the accelerating cavity configured to receive the charged particles therethrough; wherein the apertures of the cells are each sized to output a beam with a focal spot size less than 0.5 millimeters Full Width at Half Maximum (FWHM) spot diameter free of magnets.

Example 2: The linear accelerator of example 1, wherein the apertures of the cells have a diameter of less than 2.5 millimeters.

Example 3: The linear accelerator of example 1, wherein the apertures of the cells have a diameter of between one millimeter and 2.5 millimeters.

Example 4: The linear accelerator of example 1, the accelerator structure further comprising a side hole defined by the accelerator structure, the side hole positioned on a circumference of each of the accelerating cavities and configured to allow a tuning probe or a shorting rod to be placed through the accelerating cavities from a side.

Example 5: The linear accelerator of example 1, wherein the accelerator structure further comprises a side cavity defined by the accelerator structure such that the accelerator structure forms a Side Couple Bi-Periodic Structure (SCBPS), wherein the side cavities are configured for tuning the accelerator structure.

Example 6: The linear accelerator of example 5, wherein each of the side cavities further define a side aperture configured to receive a tuning probe or a shorting rod for tuning.

Example 7: The linear accelerator of example 5, wherein each of the side cavities comprise two sets of side cavities on opposite sides of the accelerating cavities, wherein the two sets of side cavities and the accelerating cavities have parallel axis and aligned central apertures in each cavity, wherein the central apertures of the two sets of side cavities are sized and shaped to permit a shorting rod or a tuning probe through multiple of the side cavities.

Example 8: The linear accelerator of example 7, wherein the central apertures of the two sets of side cavities have a diameter of 2.5 millimeters or greater.

Example 9: The linear accelerator of example 1, wherein the aperture into the accelerating cavity is configured to receive an alignment rod and a detuning rod.

Example 10: An acceleration cell for an accelerator structure of a linear accelerator, the cell comprising: a chamber body; an accelerating cavity defined by the chamber body; and an aperture defined by the chamber body that forms an opening into the accelerating cavity configured to receive charged particles therethrough; wherein the aperture has a diameter of less than 2.5 millimeters.

Example 11: The acceleration cell of example 10, wherein the aperture is sized to output a beam with a focal spot size less than 0.5 millimeters Full Width at Half Maximum (FWHM) spot diameter free of magnets.

Example 12: The acceleration cell of example 10, wherein the aperture has a diameter of between one millimeter and 2.5 millimeters.

Example 13: The acceleration cell of example 10, further comprising side holes defined by the chamber body positioned on a circumference of the accelerating cavity and configured to allow a tuning probe or a shorting rod to be placed through the accelerating cavity from a side.

Example 14: The acceleration cell of example 10, further comprising a side cavity defined by the chamber body such that the acceleration cell can be combined with other acceleration cells to form a Side Couple Bi-Periodic Structure (SCBPS), wherein the side cavity is configured for receiving a tuning instrument.

Example 15: The acceleration cell of example 14, wherein the side cavity includes at least one tuning aperture configured to receive a tuning probe or a shorting rod.

Example 16: The acceleration cell of example 15, wherein the tuning aperture is defined along a side of the side cavity.

Example 17: The acceleration cell of example 15, wherein the tuning aperture is parallel to the aperture that forms an opening into the accelerating cavity.

Example 18: The acceleration cell of example 15, wherein the tuning aperture has a diameter of 2.5 millimeters or greater.

Example 19: The acceleration cell of example 10, wherein the aperture that forms an opening into the accelerating cavity is configured to receive an alignment rod and a detuning rod.

Example 20: A method for manufacturing an accelerator structure of a linear accelerator, the method comprising: manufacturing a plurality of cells from a conductive material, each cell comprising a portion of an accelerating chamber and the material defining a beam aperture to receive charged particles therethrough; assembling the plurality of cells in a vertical position; placing an alignment rod through the beam apertures while the plurality of cells are positioned vertically; and removing the alignment rod after placing the cells in a brazing furnace and before closing a bell jar for brazing.

Example 21: The method of example 20, wherein the beam apertures are sized to output a beam with a focal spot size less than 0.5 millimeters Full Width at Half Maximum (FWHM) spot diameter free of magnets.

Example 22: The method of example 20, wherein the beam apertures have a diameter of between one millimeter and 2.5 millimeters.

Example 23: The method of example 20, further comprising tuning the accelerator structure by inserting a tuning probe or shorting rod into tuning holes of a set of coupling chambers of the plurality of cells.

Example 24: The method of example 23, wherein the tuning holes are perpendicular to the beam apertures.

Example 25: The method of example 23, the tuning holes are parallel with the beam apertures and the tuning probe or shorting rod extends through multiple coupling chambers.

Example 26: The method of example 20, further comprising tuning the accelerator structure by inserting a tuning probe or shorting rod into tuning holes along a diameter of the cells.

Example 27: An acceleration cell for an accelerator structure of a linear accelerator, the cell comprising: a housing defining an acceleration chamber comprising a first aperture to receive charged particles therethrough; and a coupling chamber defined by the housing adjacent to the acceleration chamber, the coupling chamber comprising a second aperture; wherein the second aperture of the coupling chamber is larger than the first aperture of the acceleration chamber.

Example 28: The acceleration cell of example 27, wherein the first aperture is sized to output a beam with a focal spot size less than 0.5 millimeters Full Width at Half Maximum (FWHM) spot diameter free of magnets.

Example 29: The acceleration cell of example 27, wherein the first aperture has a diameter of between one millimeter and 2.5 millimeters.

Example 30: The acceleration cell of example 27, wherein the second aperture is sized and shaped to receive tuning instruments.

Example 31: The acceleration cell of example 27, wherein the second aperture has a diameter of 2.5 millimeters or greater.

Example 32: A method for manufacturing an accelerator structure of a linear accelerator, the method comprising: manufacturing a plurality of cells from a conductive material, each cell comprising a portion of an accelerating chamber; assembling the plurality of cells; brazing the plurality of cells; and defining a straight through hole through the plurality of cells after brazing to form beam apertures configured to receive charged particles into the accelerating chambers.

Example 33: The method of example 32, wherein the straight through hole is produced using a laser.

Example 34: The method of example 32, wherein the straight through hole is sized to output a beam with a focal spot size less than 0.5 millimeters Full Width at Half Maximum (FWHM) spot diameter without magnets.

Example 35: The method of example 32, wherein the straight through hole has a diameter of less than 2.5 millimeters.

Example 36: A method for manufacturing an accelerator structure of a linear accelerator, the method comprising: manufacturing a plurality of cells from a conductive material, each cell comprising a portion of an accelerating chamber and a beam aperture to receive charged particles therethrough; assembling the plurality of cells in a vertical position; aligning the plurality of cells with an alignment tool; and brazing the plurality of cells.

Example 37: The method of example 36, wherein the alignment tool comprises an alignment rod.

Example 38: The method of example 36, wherein the alignment tool comprises a laser.

Example 39: A method for inspecting an object using penetrating radiation, the method comprising: providing charged particles to a linear accelerator; providing RF power to the linear accelerator; and acquiring an image of an object behind a steel plate with a width of greater than one inch without assistance of magnets for focusing the charged particles.

Example 40: The method for inspecting of example 39, wherein the linear accelerator comprises a plurality of cells defining accelerating cavities and apertures into the accelerating cavities.

Example 41: The method for inspecting of example 40, wherein the apertures are sized to output a beam with a focal spot size less than 0.5 millimeters Full Width at Half Maximum (FWHM) spot diameter free of magnets.

Example 42: The method for inspecting of example 40, wherein the apertures of the cells have a diameter of less than 2.5 millimeters.

Any of the above-described embodiments may be combined with any other embodiment (or combination of embodiments), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein but may be modified within the scope and equivalents of the appended claims.

1. A linear accelerator comprising:
a particle source to generate charged particles;
a radiofrequency (RF) source configured to generate RF power; and
an accelerator structure coupled to the particle source and the RF source, the accelerator structure comprising a plurality of cells arranged adjacent to one another, each cell defining an accelerating cavity and an aperture into the accelerating cavity configured to receive the charged particles therethrough;
wherein the apertures of the cells are each sized to output a beam with a focal spot size less than 0.5 millimeters Full Width at Half Maximum (FWHM) spot diameter free of magnets.

2. The linear accelerator of claim 1, wherein the apertures of the cells have a diameter of less than 2.5 millimeters.

3. The linear accelerator of claim 1, wherein the apertures of the cells have a diameter of between one millimeter and 2.5 millimeters.

4. The linear accelerator of claim 1, the accelerator structure further comprising a side hole defined by the accelerator structure, the side hole positioned on a circumference of each of the accelerating cavities and configured to allow a tuning probe or a shorting rod to be placed through the accelerating cavities from a side.

5. The linear accelerator of claim 1, wherein the accelerator structure further comprises a side cavity defined by the accelerator structure such that the accelerator structure forms a Side Couple Bi-Periodic Structure (SCBPS), wherein the side cavities are configured for tuning the accelerator structure.

6. The linear accelerator of claim 5, wherein each of the side cavities further define a side aperture configured to receive a tuning probe or a shorting rod for tuning.

7. The linear accelerator of claim 5, wherein each of the side cavities comprise two sets of side cavities on opposite sides of the accelerating cavities, wherein the two sets of side cavities and the accelerating cavities have parallel axis and aligned central apertures in each cavity, wherein the central apertures of the two sets of side cavities are sized and shaped to permit a shorting rod or a tuning probe through multiple of the side cavities.

8. The linear accelerator of claim 7, wherein the central apertures of the two sets of side cavities have a diameter of 2.5 millimeters or greater.

9. The linear accelerator of claim 1, wherein the aperture into the accelerating cavity is configured to receive an alignment rod and a detuning rod.

10. An acceleration cell for an accelerator structure of a linear accelerator, the cell comprising:
a chamber body;
an accelerating cavity defined by the chamber body; and
an aperture defined by the chamber body that forms an opening into the accelerating cavity configured to receive charged particles therethrough;
wherein the aperture has a diameter of less than 2.5 millimeters.

11. The acceleration cell of claim 10, wherein the aperture is sized to output a beam with a focal spot size less than 0.5 millimeters Full Width at Half Maximum (FWHM) spot diameter free of magnets.

12. The acceleration cell of claim 10, wherein the aperture has a diameter of between one millimeter and 2.5 millimeters.

13. The acceleration cell of claim 10, further comprising side holes defined by the chamber body positioned on a circumference of the accelerating cavity and configured to allow a tuning probe or a shorting rod to be placed through the accelerating cavity from a side.

14. The acceleration cell of claim 10, further comprising a side cavity defined by the chamber body such that the acceleration cell can be combined with other acceleration cells to form a Side Couple Bi-Periodic Structure (SCBPS), wherein the side cavity is configured for receiving a tuning instrument.

15. The acceleration cell of claim 14, wherein the side cavity includes at least one tuning aperture configured to receive a tuning probe or a shorting rod.

16. The acceleration cell of claim 15, wherein the tuning aperture is defined along a side of the side cavity.

17. The acceleration cell of claim 15, wherein the tuning aperture is parallel to the aperture that forms an opening into the accelerating cavity.

18. The acceleration cell of claim 15, wherein the tuning aperture has a diameter of 2.5 millimeters or greater.

19. The acceleration cell of claim 10, wherein the aperture that forms an opening into the accelerating cavity is configured to receive an alignment rod and a detuning rod.

20. An acceleration cell for an accelerator structure of a linear accelerator, the cell comprising:
a housing defining an acceleration chamber comprising a first aperture to receive charged particles therethrough, wherein the first aperture is sized to output a beam with a focal spot size less than 0.5 millimeters Full Width at Half Maximum (FWHM) spot diameter free of magnets, and wherein the first aperture has a diameter of between one millimeter and 2.5 millimeters; and
a coupling chamber defined by the housing adjacent to the acceleration chamber, the coupling chamber comprising a second aperture sized and shaped to receive tuning instruments;
wherein the second aperture of the coupling chamber is larger than the first aperture of the acceleration chamber.
